(19) United States
(12) Patent Application Publication
(10) Pub. No.: US 2025/0050374 A1
(43) Pub. Date: Feb. 13, 2025

(54) DISPENSING BAR FOR A GRANULAR OR POWDER PRODUCT

(71) Applicant: SYSTEM CERAMICS S.P.A, FIORANO MODENESE (MODENA) (IT)

(72) Inventor: Ivan GHIRELLI, CASTELLARANO (REGGIO EMILIA) (IT)

(21) Appl. No.: 18/720,171

(22) PCT Filed: Nov. 25, 2022
(86) PCT No.: PCT/IB2022/061418

§ 371 Date: Jun. 14, 2024

(30) Foreign Application Priority Data
Dec. 21, 2021 (IT) 102021000032054

(51) Int. Cl. B05C 19/04; B05C 19/00; B05C 19/06

(52) U.S. Cl. CPC B05C 19/04; B05C 19/008; B05C 19/06

(57) ABSTRACT

Dispensing bar for a product, such as a granular or powder material, that includes a plurality of dispensing devices, each having a dispensing channel, provided with an inlet opening for the product and an outlet opening through which the product can be dispensed, a reservoir, placed in communication with the dispensing devices that contains the product, wherein the dispensing devices are distributed along an alignment direction, along at least one row, so as to define a deposition front parallel to the alignment direction such that it comprises a support structure, provided with a first portion, with which the reservoir is associated, and a second portion, with which the dispensing devices and the suction means are associated.

The present invention relates to a dispensing bar, for the controlled dispensing of a product such as, for example, a granular or powder material, such as an atomized ceramic material.

The invention is useful for the decoration of ceramic tiles.

As is known, the decoration of ceramic tiles substantially occurs with two main techniques.

A first technique involves applying the decoration on the raw tile by means of ink jet printers. The decoration is applied on the tile after pressing and before firing.

A second technique involves applying the decoration, always in a step prior to firing the tile, in the form of granular or powder material.

In this second technique, the granular or powder material which forms the decoration is deposited by means of devices of varying nature.

Some of the devices currently used involve the deposit of the material by gravity, through unloading openings provided with a closure means which can be operated in a controlled manner. The current devices, even those of a more complex type, do not however allow the amount or the position of the material deposited to be controlled precisely. The current devices, in substance, are only useful for realising decorations in the form of relatively imprecise shading or veining.

Recently, the applicant has designed and developed a dispensing device for granular and/or powder materials which overcomes the technological limits summarised above.

Such a dispensing device, described in publication WO2020/183353, comprises a dispensing channel, provided with an inlet opening for the material to be dispensed and with an outlet opening, through which the material can be dispensed downwards. The dispensing device comprises a suction means, provided to retain, upon command, at least a part of granular or powder material inside the dispensing channel, so as to form an accumulation that obstructs the dispensing channel and prevents the flow of material. Dispensing control substantially takes place through the control of the suction means. In particular, the activation of the suction means blocks the dispensing of the material, whereas the deactivation of the suction means, possibly accompanied by an auxiliary jet of air to fluidise the material, results in the dispensing of the material.

By actuating a control for very quick activation/deactivation time cycles, i.e. by using very quick activation/deactivation frequencies for the suction means, it is possible to dispense very small quantities of material very close to one another in succession. Thanks to this type of control, made possible by the structure of the dispensing device, it is possible to obtain a dispensing of a very similar product in terms of precision and dimension of the dispensed mass, to the dispensing of liquid obtainable with an ink jet printer.

Various dispensing devices of the type described above can be arranged adjacent to one another along an alignment direction, with the outlet openings adjacent to one another and facing in the same direction, so as to form a dispensing bar. Such dispensing bar has a deposition front, substantially defined by the total area of the outlet openings of the various dispensing devices, which has a certain length. A support can be made to transit below the deposition bar, to receive the material dispensed by the various dispensing devices, like what happens in ink jet printers. The precise control of the individual dispensing devices enables well defined decorations to be realised with a predefined conformation.

The dispensing device and the bar described above produce very defined and precise decorations, with a decisively superior quality with respect to those obtainable with previously used devices.

The supply of product and the management of the individual dispensing devices of a dispensing bar require the presence of at least one product containment reservoir, conduits or channels of connection between said reservoir and each dispensing device, as well as a rather complex pneumatic circuit for the control of each dispensing device.

In addition, both the dispensing devices, the product reservoir and the pneumatic control circuit require periodic or emergency maintenance operations, which are not necessarily simultaneous with each other.

The object of the present invention is to offer a dispensing bar that allows an organized and compact arrangement of all the parts necessary for the controlled dispensing of the product. Another object of the present invention is to offer a dispensing bar that facilitates access to the various parts, independently of each other, to limit the disassembly and/or removal operations.

Features and advantages of the present invention will more fully emerge from the following detailed description of an embodiment of the present invention, as illustrated in a non-limiting example in the accompanying figures, in which:

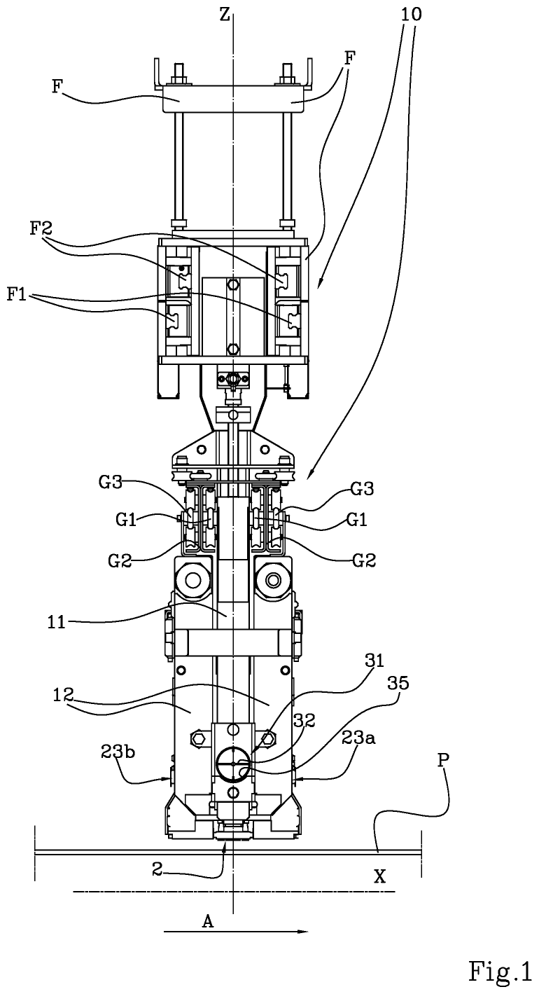

FIG. 1 shows a frontal, vertical elevation view of a dispensing bar according to the present invention;

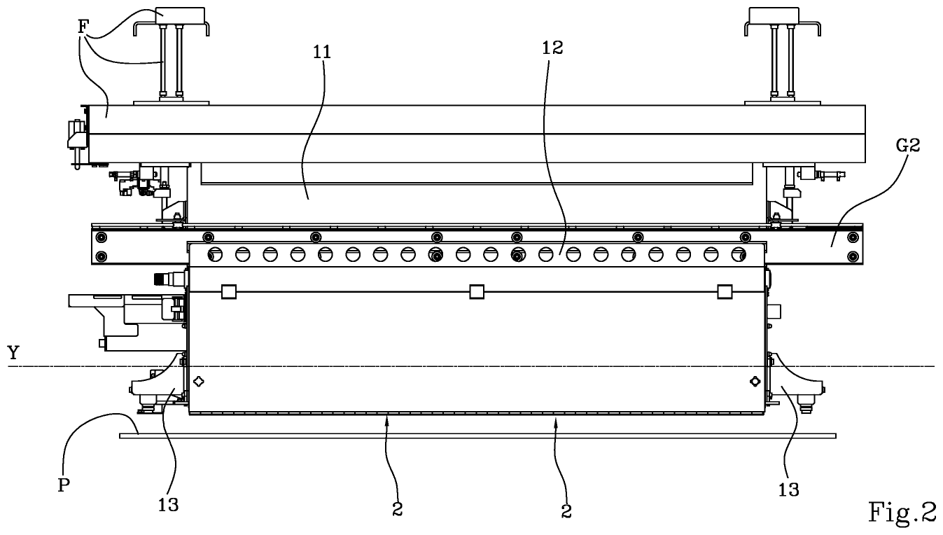

FIGS. 2 to 5 show the dispensing bar of FIG. 1 viewed from the left, in various operating configurations;

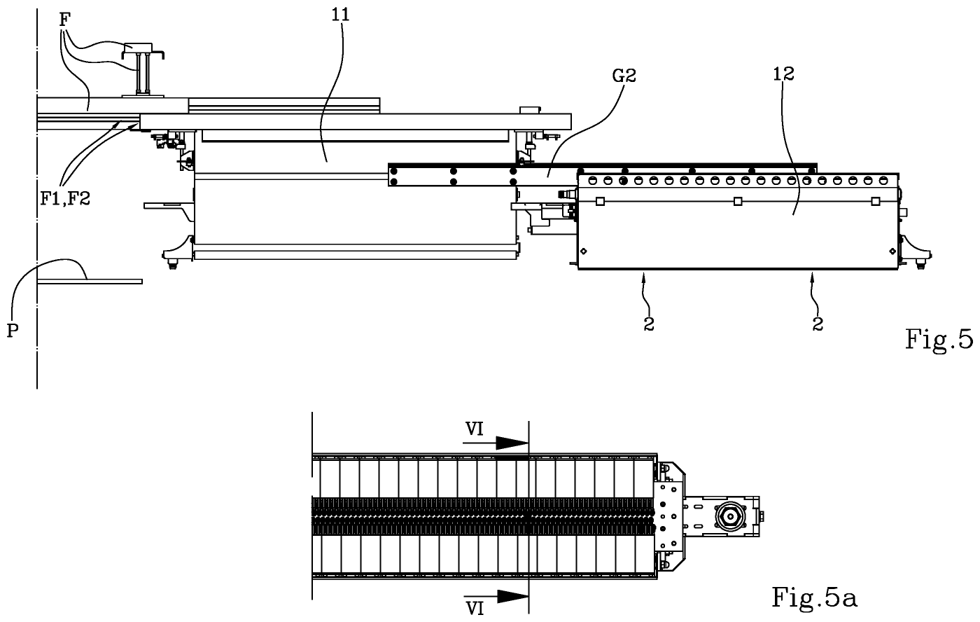

FIG. 5a shows a portion of the dispenser bar seen from below;

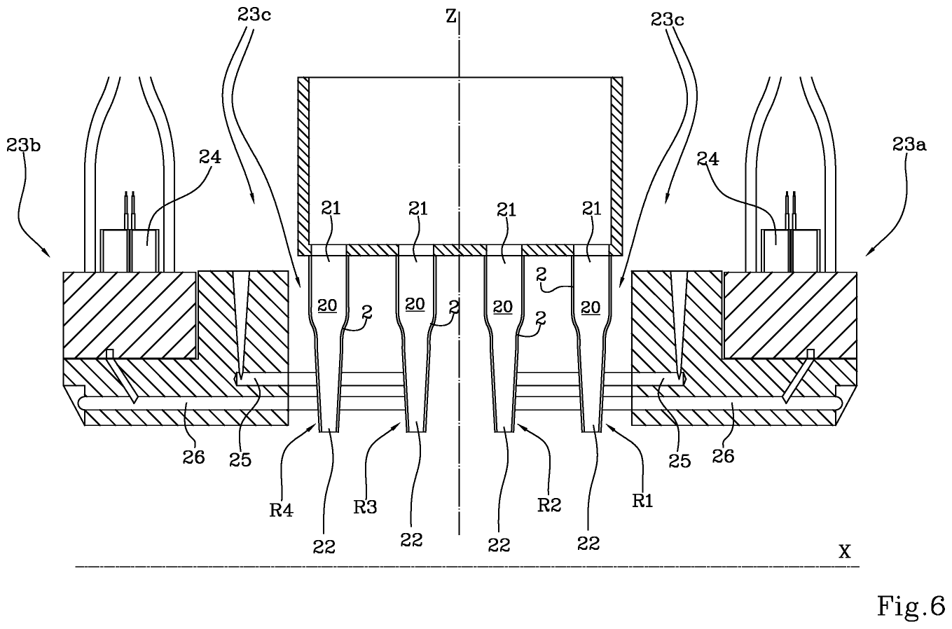

FIG. 6 shows the dispensing bar, viewed in magnification and in section on the plane VI-VI of FIG. 5a;

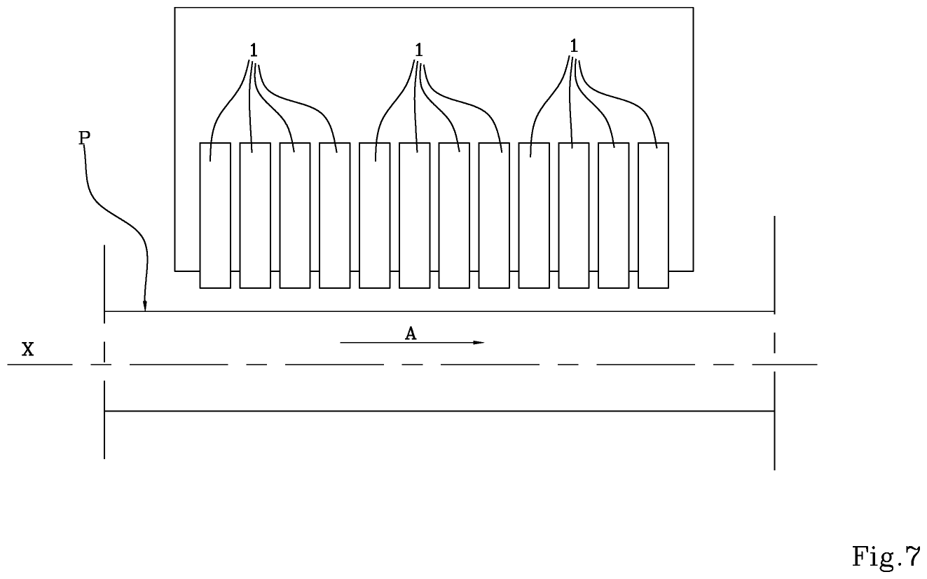

FIG. 7 shows a schematic view of a dispensing machine comprising a plurality of dispensing bars according to the present invention.

In the following description with the name “product”, reference will be made to a granular or powder material, for example an atomized ceramic material or of other type.

The dispensing bar according to the present invention comprises a plurality of dispensing devices (2), each of which comprises a dispensing channel (20), provided with an inlet opening (21) for the product and an outlet opening (22) through which the product can be dispensed downwards; Each dispensing device further comprises a suction means (23), provided to retain, upon command, at least a part of product inside the dispensing channel, so as to form an accumulation which obstructs the dispensing channel and prevents the flow of material.

In a preferred embodiment, the suction means (23) comprises at least a first control conduit (25), adapted to be connected to a suction or negative pressure source, and a solenoid valve (24), arranged along a second control conduit (26). In essence, the first control conduit (25) and the second control conduit (26) open into a predetermined area of the dispensing channel (20), opening onto the wall that delimits the dispensing channel (20). The first control conduit (25) is also connected to a low pressure, i.e. to an aspirator or a negative pressure reservoir, while the second control conduit (26) is connected to a high pressure, i.e. to a pressure greater than the pressure to which the first control conduit (25) is connected. The solenoid valve (24), located along the second control conduit (26), can be activated between an open configuration, in which the dispensing channel (20) is in communication with the high pressure, and a closed configuration, in which the dispensing channel (20) is not in communication with the high pressure. In the open configuration for opening the solenoid valve (24) the product is dispensed, since the product is not held in contact with the side wall of the dispensing channel (20).

By actuating a control for very quick activation/deactivation time cycles, i.e. by using very quick activation/deactivation frequencies for each solenoid valve (24) it is possible to dispense very small quantities of material very close to one another in succession. Thanks to this type of control, made possible by the structure of the dispensing device, it is possible to obtain a dispensing of a very similar product in terms of precision and dimension of the dispensed mass, to the dispensing of liquid obtainable with an ink jet printer.

In particular, a control module, not depicted, is arranged to control, i.e. to activate/deactivate the suction means, or more precisely to place each dispensing channel (20) in communication with the respective suction means, i.e. with the respective control conduits (25). Using a specific algorithm, the control module controls the dispensing of the product through each dispensing device (2), activating or deactivating the solenoid valves (24). By realising controlled dispensing/non-dispensing cycles for each dispensing device (2), and by realising a relative displacement between the dispensing bar (1) and an underlying support, it is possible to deposit a layer of product in a controlled manner on the underlying support itself.

A dispensing device (2) of the type mentioned above is described in patent publication WO2020/183353, which is hereby incorporated by reference. The dispensing devices (2) are distributed along an alignment direction (Y), along at least one row (R1, R2, R3, R4), so as to define a deposition front parallel to the alignment direction (Y), i.e. so as to deposit the product on a band parallel to the alignment direction (Y). In the depicted, non-limiting embodiment, there are several rows of dispensing devices (2). Preferably, the outlet openings (22) of the dispensing devices (2) lie on the same horizontal plane, so that the height from which the material is dispensed is the same for all the dispensing devices (2) and no interference or irregularities occur in the deposition.

The dispensing bar according to the present invention also comprises a reservoir (3), placed in communication with the dispensing devices (2) and intended to contain the product to be dispensed. Preferably the reservoir (3) is placed above the dispensing devices (2). In the depicted embodiment, the reservoir (3) has a prismatic conformation, with a predominant dimension arranged substantially parallel to the alignment direction (Y). The reservoir (3) has a lower opening, which extends along the alignment direction (Y) and faces substantially all the inlet openings (21) of the dispensing devices (2). In this way, the product tends to constantly descend towards the dispensing devices (2), supplying the dispensing channels (20).

The dispensing bar comprises a support structure (10), provided with a first portion (11) and with a second portion (12).

The reservoir (3) is associated with the first portion (11). The suction means (23) and the dispensing devices (2) are associated with the second portion (12).

Advantageously, the second portion (12) is slidable relative to the first portion along a direction parallel to the alignment direction (Y), so as to assume an operating position, in which the dispensing devices (2) are connected to the reservoir (3) and dispensing of the product is possible, and a maintenance position, in which it is possible to access at least the inlet openings (21) of the dispensing devices (2). Preferably, in the maintenance position the dispensing devices (2) are not connected to the reservoir (3).

The locking means, known in the sector, is arranged to lock the second portion (12) in the operating position. This locking means can be activated between a locking configuration, in which it prevents the second portion (12) from sliding, and an unlocking configuration, in which it allows the second portion (12) to slide. Various examples of locking means are known to the person skilled in the art.

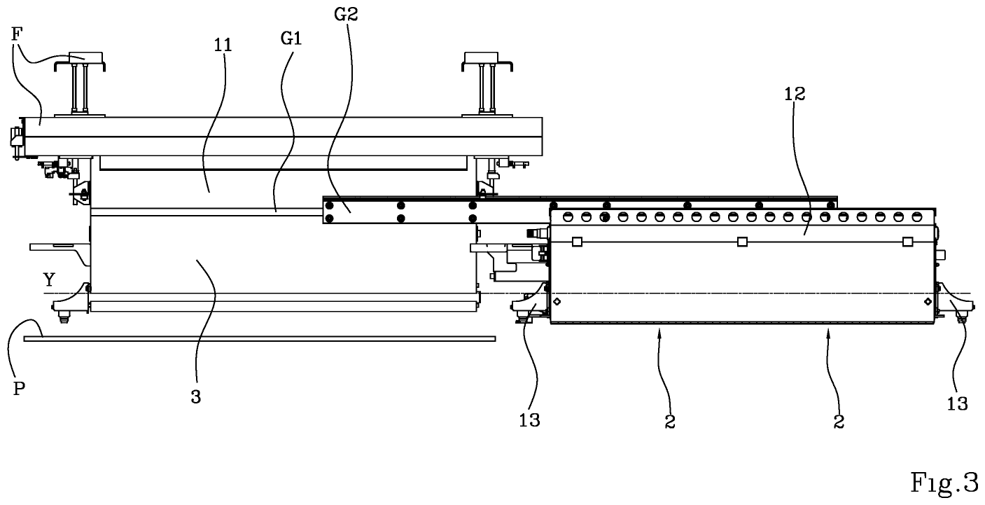

As shown in FIGS. 3, 4, 5, the possibility of displacing the first portion (11) and the second portion (12) between them allows to access at least some parts of the dispensing bar, in order to easily carry out maintenance and/or restoration operations or other.

In the maintenance position, the second portion (12) is displaced with respect to the first portion (11) along the alignment direction (Y), being thus placed substantially outside the encumbrance of the first portion (11), so as to be directly accessible, at least in the area of the inlet openings (21) of the dispensing devices (2). This makes it possible to act directly on each dispensing device (2), for example in order to remove any obstructions.

In the operating position of the portions (11,12), each dispensing device (2) is connected to the reservoir (3).

In the depicted embodiment, the suction means (23), associated with the second portion (12), is divided into two groups (23a,23b) separated by a housing space (23c), which has a predominant dimension parallel to the alignment direction (Y). Each group (23a,23b) is associated with a flank of the second portion (12).

In the operating position, depicted in FIG. 2, the reservoir (3), associated with the first portion (11) is arranged in the housing space (23c). In particular, in the operating position the reservoir (3) is arranged above the dispensing devices (2). As already mentioned, the reservoir (3) has a lower opening, which extends along the alignment direction (Y). In the operating position, this lower opening faces substantially all the inlet openings (21) of the dispensing devices (2). In this way, the product tends to constantly descend towards the dispensing devices (2), supplying the dispensing channels (20).

As already mentioned, the dispensing devices (2) are distributed along an alignment direction (Y), along one or more rows (R1, R2, R3, R4) parallel to each other. In the depicted exemplary embodiment, in which there are four rows of dispensing devices, the dispensing devices of two contiguous rows (R1,R2) are supplied by the suction means of a first group (23a), arranged on a first side of the second portion (12). The dispensing devices of other two contiguous rows (R1,R2) are supplied by the suction means of a second group (23b), arranged on a second side of the second portion (12). The reservoir (3) is likewise flanked by the suction means (23), i.e. it is inserted into the housing space (23c) defined between the suction means (23), and is vertically superimposed on the dispensing devices (2).

The structure of the dispensing bar according to the present invention, configured as described above for the operating position, i.e. with the reservoir (3) placed in the housing space (23c) defined between the suction means (23), is particularly compact and efficient, and allows to place several dispensing bars (1) adjacent and parallel to each other to create a dispensing machine that will be better described later.

FIG. 3 depicts the second portion (12) in the maintenance position. In this configuration it is possible to access the dispensing devices (2) and the suction means (23).

The dispensing bar according to the present invention makes it possible to realise a dispensing machine, schematically shown in FIG. 7. The dispensing machine is capable of depositing, on an underlying surface, a layer of product comprising a decoration.

To this end, two or more dispensing bars (1) according to the present invention are arranged adjacent to one another, with parallel alignment directions (Y), so that the deposition fronts of the dispensing bars (1) are consecutive to each other and aligned along a direction of forward travel (X) perpendicular to the alignment direction (Y). Each dispensing bar (1) can be supplied with a product of similar or different characteristics, for example by colouring, compared to the other dispensing device bars.

The machine also comprises a support surface (P), located below the dispensing bars (1) and movable along the forward travel direction (X), for example in the direction “A” of FIG. 1. The support surface (P) is arranged to receive the product dispensed by the bars (1).

The dispensing bars (1) are coordinated with each other by the control module already mentioned, to deposit the product making chromatic effects or tracing predetermined decorations. In essence, the independent control of each dispensing device (2) allows the product to be dispensed in order to reproduce predetermined patterns or decorations. As already pointed out, through the actuation of controlled dispensing/non-dispensing cycles for each dispensing device (2), and by moving forward the support surface (P) at a preset speed, it is possible to dispense the product in such a way as to form a layer that reproduces pre-established patterns and/or decorations, with operating methods substantially similar to those implemented by an inkjet printer. In the case of the present invention, each dispensing device (2) performs a function similar to that of a nozzle of an inkjet printer.

The first portion (11) is slidable between an operating position and a maintenance position relative to a frame (F) associated with the support structure or overall frame of the dispensing machine. In particular, the first portion (11) and the second portion (12), with the respective parts, are located below the frame (F). In other words, the dispensing bar is located below the frame (F), i.e. it is hanging on the frame (F) slidably along the alignment direction (Y). Preferably, the frame (F) is in the form of a crosspiece, arranged substantially parallel to the alignment direction (Y). A system of guides (F1, F2), known in the sector and illustrated only schematically, is interposed between the frame (F) and the dispensing bar, i.e. between the frame (F) and the first portion (11). For example, the system of guides comprises two pairs of guides (F1,F2) arranged symmetrically with respect to a median vertical plane (Z) of the dispensing bar. For example, the guides (F1,F2) are of the recirculating ball or slide type.

The locking means, known in the sector, is arranged to lock the first portion (11) in its operating position with respect to the frame (F). This locking means can be activated between a locking configuration, in which it prevents the first portion (11) from sliding, and an unlocking configuration, in which it allows the first portion (11) to slide. Various examples of locking means are known to the person skilled in the art. In the depicted embodiment, a first guide (G1,G2,G3) is interposed between the first portion (11) and the second portion (12). Said first guide comprises a first profile (G1), integral with the first portion (12), and a second profile (G2), slidable along the first profile (G1) and slidable relative to the second portion (12). The first guide also comprises a third profile (G3), integral with the second portion (12), along which the second profile (G2) is slidable. In a known manner, a plurality of rollers or wheels are interposed between the three profiles (G1,G2,G3) to define a sliding direction parallel to the alignment direction (Y).

Preferably the first guide (G1,G2,G3) comprises a pair of first profiles (G1), a pair of second profiles (G2) and a pair of third profiles (G3). The profiles of each pair are arranged symmetrical with respect to a median vertical plane (Z) of the dispensing bar.

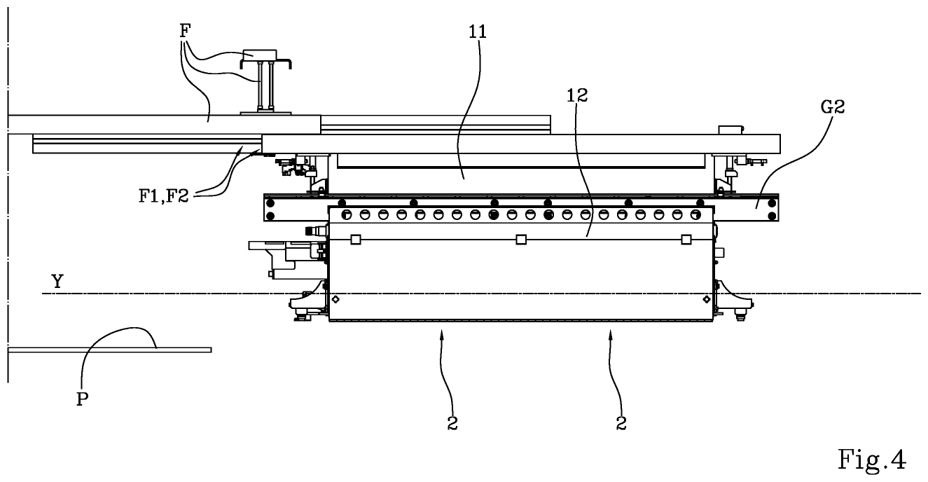

FIG. 4 shows an intermediate configuration, in which the first portion (11) is in the maintenance position, while the second portion (12) is in the operating position with respect to the first portion (11). In other words, in the intermediate configuration of FIG. 4, the group formed by the reservoir (3), the dispensing devices (2) and the suction means (23) is extracted from the encumbrance in plan of the frame (F) of the machine. However, the dispensing devices (2) are connected to the reservoir (3) in operating conditions for dispensing the material. This makes it possible to test the correct operation of the dispensing devices (2) by unloading the material in a position external to the frame (F), i.e. outside the support surface (P).

FIG. 5 depicts the first and second portion (11,12) both in the maintenance position. In this configuration it is possible to access the dispensing devices (2), including the inlet openings (21) of the dispensing channels (20) and the dispensing channels (20) themselves. In this configuration it is also possible to access the reservoir (3) and the lower opening of the reservoir (3).

Advantageously, a shut-off valve (31) is interposed between the reservoir (3) and the dispensing devices (2). The shut-off valve (31) is adapted to assume at least a closed position, in which it interrupts the communication between the reservoir (3) and the dispensing devices (2), and an open position, in which it allows communication between the reservoir (3) and the dispensing devices (2).

The shut-off valve (31) allows the second portion (12), to which the dispensing devices (2) are associated, to be positioned in a maintenance position, avoiding the product contained in the reservoir (3) being dispersed.

In a preferred embodiment, the shut-off valve (31) comprises a shutter (32) and a seat (35) within which the shutter (32) is arranged.

In a possible embodiment, the shutter (32) comprises a plate that is rotatable about an axis parallel to the alignment direction (Y). Said plate is rotatable between a substantially horizontal closed position, in which it intercepts the passage between the reservoir (3) and the dispensing devices (2), and a substantially vertical open position, in which it leaves the passage between the reservoir (3) and the dispensing devices (2) free. Various examples of shut-off valve comprising a rotatable plate shutter, such as butterfly valves or the like, are known to the person skilled in the art, and will not be described in detail therefor.

Advantageously, two or more products, for example two or more atomized ceramics of different colour, can be supplied to the dispensing devices (2). In practice, some dispensing devices can be supplied with a first product of a certain colour, others with a second product of different colour. To this end, the bar can be provided with two separate reservoirs (3). A control module, not depicted, is adapted to control the dispensing of the product from each dispensing device (2), by activating or deactivating the suction means, i.e. by activating or deactivating each solenoid valve (24) that places a control conduit (25) in communication with a respective dispensing device (2), depending on a decoration to be made. By actuating controlled dispensing/non-dispensing cycles for each dispensing device (2), and by arranging a movable support surface (P) in advancement at a prefixed speed below the dispensing devices (2), it is possible to dispense the product so as to form a layer that reproduces pre-established patterns and/or decorations, with operating modes substantially similar to those implemented by an inkjet printer. In the case of the present invention, each dispensing device (2) performs a function similar to that of a nozzle of an inkjet printer.

1. A dispensing bar for a product, such as a granular or powder material, comprising:
a plurality of dispensing devices (2), each of which comprises a dispensing channel (20), provided with an inlet opening (21) for the product and an outlet opening (22) through which the product can be dispensed downwards;
a reservoir (3), placed in communication with the dispensing devices (2) and intended to contain the product;
wherein the dispensing devices (2) are distributed along an alignment direction (Y), along at least one row (R1, R2, R3, R4), so as to define a deposition front parallel to the alignment direction (Y);
characterised in that:
it comprises a support structure (10), provided with a first portion (11), with which the reservoir (3) is associated, and a second portion (12), with which the dispensing devices (2) and the suction means (23) are associated;
the second portion (12) is slidable relative to the first portion (11) along a direction parallel to the alignment direction (Y) so as to assume an operating position, in which the dispensing devices (2) are connected to the reservoir (3) and dispensing of the material is possible, and a maintenance position, in which it is possible to access at least the inlet openings (21) of the dispensing devices (2).

2. The dispensing bar according to claim 1, comprising: a suction means (23),
connected to the second portion (12), which is adapted to retain, on command, at least a part of the product inside the dispensing channel, so as to form an accumulation which obstructs the dispensing channel and prevents the flow of material.

3. The dispensing bar according to claim 2, wherein the suction means (23) comprises at least one control conduit (25), adapted to be connected to a suction or negative pressure source.

4. The dispensing bar according to claim 1, comprising a shut-off valve (31), interposed between the reservoir (3) and the dispensing devices (2), adapted to assume at least a closed position, in which the shut-off valve interrupts the communication between the reservoir (3) and the dispensing devices (2), and an open position, in which it allows communication between the reservoir (3) and the dispensing devices (2).

5. The dispensing bar according to claim 1, comprising at least one guide (G1,G2,G3) interposed between the first portion (11) and the second portion (12) to allow the sliding of the second portion (12) relative to the first portion (11) along the alignment direction (Y).

6. A machine according to claim 1, wherein the first portion (11) is slidable relative to a frame (F) along a direction parallel to the alignment direction (Y), between an operating position and a maintenance position.

7. A dispensing machine for depositing a layer of product comprising a decoration on an underlying surface, characterised in that the dispensing machine comprises:
two or more dispensing bars (1) according to claim 1, arranged side by side, with parallel alignment directions (Y), so that the deposition fronts of the dispensing bars (1) are consecutive to one another along a forward travel direction (X) perpendicular to the alignment direction (Y);
a support surface (P), movable along the forward travel direction (X) and positioned below the dispensing bars (1) so as to receive the product dispensed by the dispensing bars (1).

8. The dispensing machine according to claim 7, comprising a control module adapted to control the dispensing of the product from each dispensing device (2) by activating or deactivating the suction means in order to carry out controlled dispensing/non-dispensing cycles for each dispensing device (2), so as to form a layer that reproduces pre-established patterns and/or decorations on the support surface (P).
